(19) United States
(12) Patent Application Publication
(10) Pub. No.: US 2011/0212428 A1
(43) Pub. Date: Sep. 1, 2011

(54) System for Training

(76) Inventor: David Victor Baker, Morgantown, WV (US)

(21) Appl. No.: 13/030,949

(22) Filed: Feb. 18, 2011

Related U.S. Application Data
(60) Provisional application No. 61/305,709, filed on Feb. 18, 2010.

(51) Int. Cl. G09B 5/00

(52) U.S. Cl. 434/308

(57) ABSTRACT

The present invention provides for a teaching module having a training scenario database, an editor component, a student component and an artificial intelligence component. The training scenario database has a plurality of video clips, audio files and associated artificial intelligence metadata to simulate a person's personality and mood. The editor component facilitates the creation of a training scenario involving a simulated person. The student component facilitates the interaction with the training scenario by a user. The artificial intelligence component alter the simulated person's personality and mood based on the interaction by the user to provide realistic responses allowing the user to learn how to respond to the simulated person to achieve a desired result. The teaching can be located in a single computer or over a network of computers.

### REFERENCE TO PENDING APPLICATIONS

This application claims the benefit of U.S. Provisional Patent Application Ser. No. 61/305,709 filed on Feb. 18, 2010 and entitled Training Module.

### REFERENCE TO MICROFICHE APPENDIX

This application is not referenced in any microfiche appendix.

### BACKGROUND OF THE INVENTION

1. Field of the Invention

The present invention is generally directed toward a system for training. More specifically, the present invention is directed toward a gaming software platform for teaching the ability to master the diagnostic interview and provide ability to teach rapport training.

2. Background

The present invention can be utilized by individuals in various professions, including but not limited to medical professionals, law enforcement and personnel involved in psychological treatment. For purposes of illustration, but not limitation, the present invention will be discussed in the view of a medical professional. Those skilled in the art will recognize this is merely illustrative and not meant to be limiting.

For medical students attempting to master the diagnostic interview, present teaching methods are labor intensive for instructors and students, limited to fixed settings such as the classroom or the clinic and require the availability of actual patients. Many medical schools are creating instructional videos of doctor/patient interactions to help train students proper diagnosis skills which involve using actors portraying patients. One disadvantage of the prior art is that a gap exists between the essentially passive experience of watching an instructional movie and the active experience of one on one mentoring.

Accordingly, there is a need for an improved system to master the diagnostic interview

### BRIEF SUMMARY OF THE INVENTION

The present invention satisfies the needs discussed above. The present invention is generally directed toward a system for training. More specifically, the present invention is directed toward a gaming software platform for teaching the ability to master the diagnostic interview.

It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

One aspect of the present invention has a training scenario database, a computer editor component, a computer student component and a computer artificial intelligence (AI) component. The present invention can be located in a single computer or over a network of computers.

The training scenario database having a plurality of video clips, audio files and associated artificial intelligence metadata to simulate a person's personality and mood. The simulated person can take on various personalities, such as a medial patient. The training scenario database can further house a library of specific training scenarios that can be accessed by a plurality of users. Additionally, the database can hold a plurality of default responses which are used when the computer AI component is unable to respond to specific input.

The computer editor component facilitates the creation of a training scenario involving the simulated person, and can include a graphical user interface and a database connector.

The computer student component facilitates the interaction with the training scenario by a user, who can be selected from various users including medical students, and who can select a training scenario module from a library of pre-built scenarios. Each training scenario contains the necessary scripting and video clips necessary to the client software application (what the user uses) to provide the simulation experience of interacting with a virtual person for a specific situation and circumstances. Further, the interaction can be performed through questions input through text which is derived from sources such as but not limited to keyboard or speech recognition components to facilitate interaction by the user.

The computer AI component alter the simulated person's personality and mood based on the interaction by the user to provide realistic responses allowing the user to learn how to respond to the simulated person to achieve a desired result. The AI component can include a dynamically linked library (DLL1). The DLL has the capability to accept textual input from the computer student component and compare that input against keywords contained within the training scenario database. Further, the DLL has the capability to provide simulated realistic human behavior for the simulated person through the computer student component.

Upon reading the above description, various alternative embodiments will become obvious to those skilled in the art. These embodiments are to be considered within the scope and spirit of the subject invention, which is only to be limited by the claims which follow and their equivalents.

### BRIEF DESCRIPTION OF THE DRAWINGS

FIG. 1 is a schematic view of an embodiment of the present invention.

FIG. 2 is a schematic view of an embodiment of the training scenario database of the present invention.

FIG. 3 is a schematic view of an embodiment of the computer AI component of the present invention.

FIG. 4 is an illustration of an embodiment of the mapping in 3D space consisting of Trust, Topic Comfort, and Sense of Urgency.

### DESCRIPTION OF THE INVENTION

The present invention satisfies the needs discussed above. The present invention is generally directed toward a system for training. More specifically, the present invention is directed toward a gaming software platform for teaching the ability to master the diagnostic interview.

Current serious gaming training applications lack the dimensions of human emotion and, in particular intimate interpersonal emotion. The present method used in both entertainment and serious gaming software for modeling conversation between the trainee and virtual characters occurs within a limited decision tree (choose option A, B, or C). Further, the dynamics of human emotion are added to what currently exists in the present state of the art.

The present invention is based on the following concepts: human conversation is not linear, it must be modeled using a dynamic approach and that human immersion consists of visual, interactive, experiential, and emotional dimensions. Further, it is intended to teach the student about the range of interpersonal communication skills (soft skills) that are needed to successfully interact with a person, including how to establish trust with the person, how to reduce the person's anxiety, and which questions are effective in drawing out information that is needed for a diagnosis

As the user uses the present invention, they will experience conversations with patients. Sometimes the patient will be angry; sometimes the student will need to reassure the patient to make them more comfortable, and may require the student to alter their questioning approach to reassure the patient. The student will learn by trial and error through active interaction with intelligent characters that communicate their emotions.

The student will improve the effectiveness and economics of training in numerous settings. They will practice and learn in environments of their choosing, including medical situations, law enforcement situations and psychological treatment situations.

The present invention uses video clips of actors portraying patients rather than the use of real-time 3D polygonal characters to help maintain the “suspension of disbelief” and enhance the perception of human bonding. The use of video clips to represent patient responses is not exclusive. Other forms of interactivity can be utilized including procedural 3D animations of virtual characters and audio clips in the event such would be an appropriate substitute for video clips to maintain the suspension of disbelief.

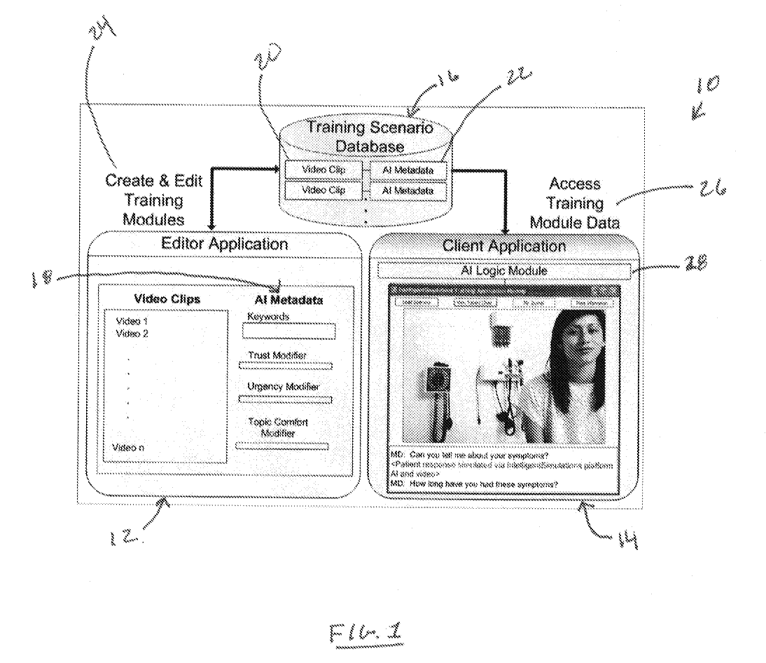

As illustrative in FIG. 1, an embodiment 10 of the present invention is disclosed. Embodiment 10 includes an editor application 12, a client application 14, an artificial intelligence (AI) module 18, and a database 16. The database 16 contains unique teaching scenarios; each comprised of a series of video clips 20 (each 5-10 seconds in length) and associated AI metadata 22. The AI metadata 22 that each video clip 20 is attributed with consists of a collection of keywords and numeric mood parameters that combine to convey the patient's personality and mood. Embodiment 10 can be delivered through a single desktop computer, through a network of computers or through a web based delivery system.

The editor application 12 is a tool to create training scenarios 24. The client application 14 is the application the trainee uses to access a specific training scenario and interact with the virtual patient. The hierarchy of the software platform provides for the creation of libraries of virtual patients (unique, individual training scenarios) via the editor application 12 which then stores each scenario into the database 16. The database 16 can then be packaged with the client application and distributed as a training solution for the trainees.

The medical student will interact with a virtual patient by entering keyboard based dialog into the client application 18 which updates an internal AI model 18. The AI module 18 will then trigger a video clip 20 from the database 16 of the patient (pre-filmed actor) to convey the patient's response to the trainee's inquiry.

The editor application 12 will consist of a graphic user interface (GUI) and a database connector. The visual fields for the GUI will represent the data fields that will be stored in the database 16 for the training scenario. There will be a list box for Videos (patient responses), and textboxes for AI metadata fields such as keywords, trust, topic comfort, and sense of urgency parameters to be associated with each patient response.

An embodiment of client application 14 includes a GUI and a database connector to access scenario information. Client application 14 will also contain the AI module 28 which will be responsible for simulating realistic human behavior for the virtual patient. Client application 14 is the training application that the trainee will use to interact with the virtual patient (via a specific training scenario loaded from the database). Client application 14 will have a textbox for the trainee to input questions/responses to the virtual patient and will have a visual capability to display the video clip representing the patient's response to the trainee's textual input.

Various database designs can be employed including a file store that is accessible via an XML scenario file and a MySQL database. Further a database connector to enable the Client and Editor applications to access the identified database can be utilized.

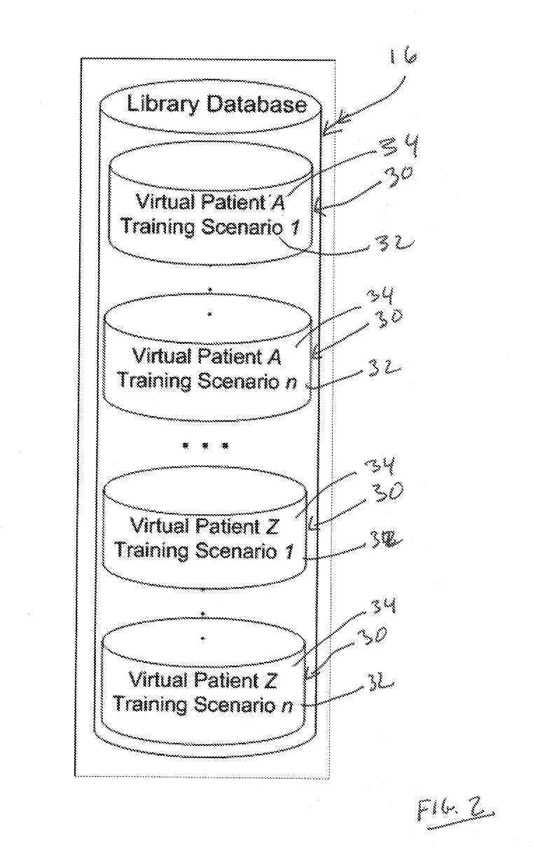

As illustrated in FIG. 2, within the database 16, a unique table 30 (with records) within the database will be created that will contain the data (video clips 20 and their associated AI metadata 22 for each unique training scenario. It is important to note that each table 30 in the database corresponds to a unique training scenario 32, and each training scenario involves a single virtual patient 34.

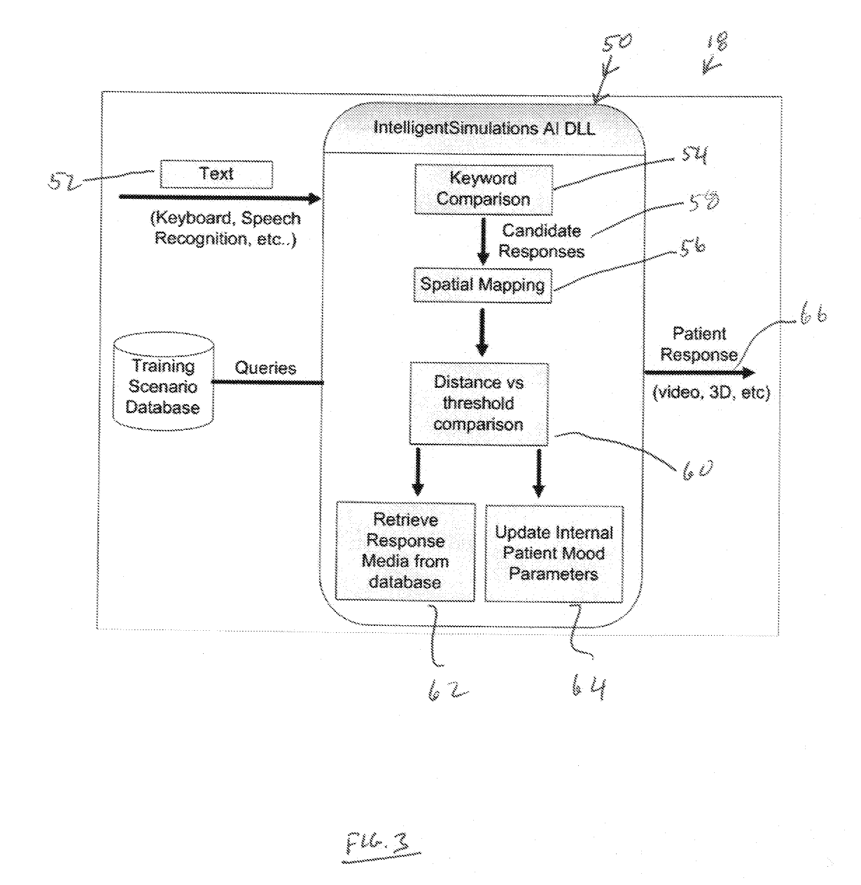

As illustrated in FIG. 3, the embodiment of AI module 18 is a software dynamically linked library (DLL) 50. The DLL 50 will have member variables to represent the vector logic proposed to model conversational metrics with particle system based logic. The DLL 50 will have the capability to accept textual input 52 and compare the typed inquiries against keywords contained in the training scenario database 54.

AI module 18 will be based on a neural network particle swarm optimization (PSO) model, which is a stochastic, population based algorithm for problem solving. PSO has been described by the following: in a conversation between two people there are many discrete dialog exchanges that develop the story between the participants and drive the conversational thread. As we build trust with another individual our sense of topic comfort will increase which means that we are more comfortable talking about a sensitive subject with a trusted individual. Analogously trainees must be able to expect that the virtual patient will behave according to anticipated rules of human interaction/conversation. We choose this approach by considering how people share ideas and talk about problems. Conversation is dynamic—as people converse their beliefs and opinions change[7]. The path of conversation is not anticipated: it wanders based on the participants dynamic input.

The use of particle systems to simulate an artificial intelligence for interpersonal communication is analogous to individual birds flying in a flock where each bird in the flock represents a potential dialog exchange at a particular time stamp during the flow of a conversation. Now consider how a flock of birds moves in unison and changes shape while flying, exhibiting perceived group intelligence, analogous to how interpersonal relationships develop and the sharing of ideas occur between conversational participants. Such movements are examples of emergent behavior: the behavior is not a property of any individual bird, but rather emerges as a property of the group. There is no leader, no overall control; instead the flock's movements are determined by the moment-by-moment decisions of individual birds, following simple rules in response to interactions with their neighbors.

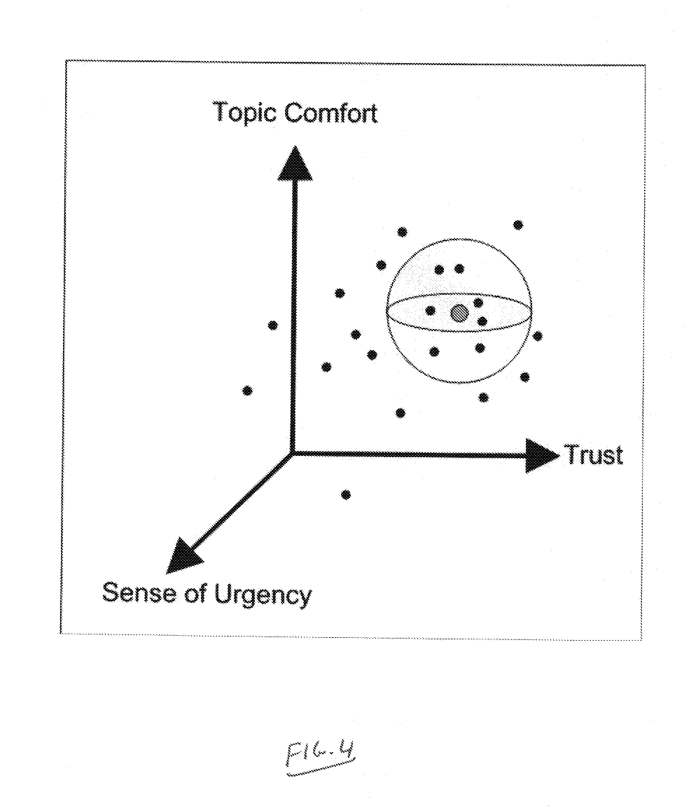

FIG. 4 illustrates an embodiment of the mapping in 3D space consisting of Trust (X axis), Topic Comfort (Y axis), and Sense of Urgency (Z axis). While FIG. 4 places Trust, Topic Comfort and Sense of Urgency on specific axis, this is merely illustrative and is not meant to be limiting. The figure depicts the 3D spatial location of each potential response contained in the subset (i.e. those with keyword hits). Each of the potential patient responses (those with keyword matches) are then converted into 3D space based on their stored metrics (trust, topic comfort, sense of urgency). The green dot represents the current state of the virtual patient's mood and the surrounding sphere represents a spatial threshold to identify the most relevant patient response. Responses that are spatially adjacent with the current virtual patient mood mimic behavior that would be expected in daily conversation. That is, as trust is built with someone, people are more apt to talk about more topics (i.e., internal keyword searching occurs within the brain). Further, emotional heuristics are factored in to create a more robust AI.

To calculate a “spatially logical” response 56 by the virtual patient, the AI module 18 will compare the values of the virtual patient's current mood (represented in 3D space) against each of the keyword matching “hits”. AI module 18 will also be capable of creating fitness functions that model the flow of a conversation and update the virtual patient's sense of trust, topic comfort, and sense of urgency to simulate the dynamic nature of a developing conversation.

To mathematically determine which video clip to play, the AI model 28 within the client application 14 will keep a score (i.e., mood parameters such as trust level) based on the appropriateness of the dialog entered by the trainee. As the trainee asks appropriate questions, the AI patient “warms up” to the trainee and metrics monitoring the patient's trust level will increase and enable the patient to respond with video clips that evolve the conversation to the next step, perhaps enabling the patient to “open up” and reveal a crucial detail. Likewise, if the trainee asks bad questions (repetitive questions or comments, or items outside the bounds of the AI's current vocabulary, the virtual patient will respond with an “I don't understand why you're asking me that” type of response and potentially reduce the trust level.

AI process depicting textual input, internal keyword and spatial mapping logic, and patient response output module architecture by taking text based input and performing a preliminary keyword comparison between the trainee's typed dialog and the keywords attached to video clips contained in the training scenario database. A collection of candidate responses 58 that are the potential virtual patient responses based on keyword scoring. The next step is to spatially map 56 the candidate responses into Cartesian space based on the stored numeric values of trust, topic comfort, and sense of urgency associated with each of the candidate responses in the database. The spatial distance is calculated between each candidate response (mapped in multidimensional space) with the spatial position of the virtual patient's current mood, M, (represented as a multidimensional point in Cartesian space). Based on this comparison, a response is retrieved 62 from the database 16. The internal mood parameters of the simulated patient are updated 64 and the response is provided to the user 66.

An example is shown below:

Let there be n particles each representing a different candidate patient response and each with associated Cartesian positions (X, Y, Z). The conversational metrics are correlated with the Cartesian axes as follows:

x→Trust, 0≦Trust≦100

y→Topic Comfort, 0≦Topic Comfort≦100

z→Sense of Urgency, 0≦Sense of Urgency≦100

Trust Higher value indicates the patient has placed a sense of trust with the treatment provider; Topic Comfort Higher value represents that the patient is very willing to discuss a topic; Sense of Urgency Higher values represent that the patient has a dire need to discuss the topic. Mood, M, is a point in Cartesian space mapped at the location of (accumulated_trust, accumulated_topic_comfort, accumulated_urgency), i.e., M=(accumulated_trust, accumulated_topic_comfort, accumulated_urgency).

To determine patient response to trainee query:

Initialize M and xi, yi, zi, and for all i based on values available from the scenario database (i.e., initial trust, initial topic comfort, initial sense of urgency)

Choose initial candidate distance threshold, D, 0≦D≦max threshold (i.e., 10)

After each dialog entry by the trainee during the conversation, update the spatial location for all candidate response particles based on trust, topic comfort, sense of urgency metadata values attached to each candidate response identified by a keyword comparison within the training scenario database:
For each candidate response 0≦i≦n;
   Update the conversational particle positions:
      xi←xi+Trusti
      yi←yi+Topic Comforti
      zi←zi+Sense of Urgencyi
Check for candidates within distance threshold D for best virtual patient response:
   For all conversational particle candidates, 0 . . . n
      Compute distance between and particle's position
      Remove candidate responses with:
   Candidate response with lowest value is best response.
   If no candidate responses with, either increase parameter D, or play tangential patient response.

Update the AI module's accumulated_trust, accumulated_topic_comfort, and accumulated_urgency variables based on the patient response.

Update the virtual patient's mood, M, as: M=f(accumulated_trust, accumulated_topic_comfort, accumulated_urgency)

The candidate response with the lowest computed distance is then accessed from the scenario database and played to represent the virtual patient's response (FIG. 5). If no suitable candidate can be found (i.e., no candidates within threshold D), the application will play a tangential response to illustrate to the trainee that the virtual patient is not ready to divulge any information about the requested conversation topic.

The scenario data contained within the database will resemble the following format:

| Scenario Name: | Diagnostic Interview |
|---|---|
| Initial Patient Trust: | 0 |
| Initial Patent Topic Comfort: | 0 |
| Initial Patient Sense of Urgency: | 0 |
| Video Clip: | 1 |
| Video Clip Name: | “Reaction to pleasant greeting.mov” |
| Keywords: | “Hello; Nice to see you” |
| Required Trust Level to Access: | 0 |
| Required Sense of Urgency to Access: | 0 |
| Required Topic Comfort Level to Access: | 0 |
| Trust Modifier: | 5 |
| Topic Comfort Modifier: | 0 |
| Sense of Urgency Modifier: | 0 |
| . . . | |
| Video Clip n | |

Example situations where the present invention could assist include the following:

A middle aged woman with abdominal pain; the doctor has decided that the injection of a particular medication is required. Upon seeing the needle, the patient becomes markedly distressed. The present invention could assist the doctor to learn how to interact with the patient and successfully calm the patient.

An elderly gentleman neglecting to take full course of antibiotics. The present invention could assist the doctor to learn how to recruit the patient's cooperation by establishing trust and a common ground, perhaps by drawing the patient out through the love of a new grandchild and the patient's own desire to remain healthy.

An adolescent female becoming sexually active; her parents have sent her to the doctor to consult about birth control. Initial questioning by the doctor reveals that the patient is uneasy about discussing birth control and the patient is also combative regarding her parents. The present invention could be used to assist the doctor to learn how to open channels of communication with the patient by requiring that the doctor act as both a counselor and a physician.

An average medical interview lasts thirty minutes. The training scenario for this interview will require an instructional designer to work with subject matter experts (SMEs) to craft a script based on a typical session between the patient and the health care provider. Each script will be based on a prescribed story deemed important by the SME. The script will consist of the detailed conversational interactions between the patient and health care provider. The script will have variations of each response given by the virtual patient. The script will also consist of tangential reactions by the virtual patient to provide responses to trainee questions/input that are not explicitly contained within the training scenario. The script will also contain transition reactions including but not limited to the idle video of the virtual person/patient while they wait for user input. Additionally, if the user does not interact with the software within a certain time frame the script will contain patient responses such as but not limited to “Is there something you wanted to ask me?” Each response by the virtual patient will be correlated with a collection of keywords and numerical based mood parameters that control the AI calculations to determine the virtual patient's response to the trainee's questioning during the experience.

Once the instructional designer and SMEs have created a script, patient's response will be filmed as video clips using an actress. The training scenario is created by inputting the information and video clips from the script into the editor application. The AI behaviors for the patient can be tweaked to enable numerous variations to the original scripted story.

The actress will portray the virtual patient's responses based on the “mood” specified within the script. Each of the many responses (i.e., one for each emotional variation) will be filmed using a video camera and stored as unique video clips (i.e., three clips per question). To be clear, each patient response (portrayed by an actress) is a unique video clip that will be stored and attributed into the database by the Editor.

The live actress will act out multiple responses to each unique question within a specific training scenario and those discrete responses will be saved as separate video clips within the scenario database via our Editor application. Within the Editor application each video clip for a given training scenario will be attributed with AI metadata (keywords, and numeric values for trust, sense of urgency, topic comfort metrics) and saved to the training scenario database.

If the virtual patient is asked “How are you today?” by the trainee, the AI module could then have her respond with either a sad reply such as “I′m not comfortable being here”, an angry response “My parent's forced me here! I'm having a terrible day!” or a happy response “What a terrific day!” Logistically, the training scenario will be focused on a specific demeanor of the patient; however the underlying concept remains the same so that the virtual patient can come to life through a variety of potential responses. If the trainee starts with an angry patient and asks the correct questions at appropriate times during the conversation, the virtual patient can be designed to become happier, or expose critical information needed to help the trainee diagnose the patient and move the conversation forward.

Each scenario corresponds to a collection of video clips: An individual training scenario is represents a specific conversation between two individuals about a specific topic. In the example we can focus on a conversation between a physician and the adolescent female patient during a medical interview at the gynecologist's office. To support the story of the conversational dialog between the treatment provider (trainee) and the female patient (virtual patient) a collection of video clips are needed, each one consisting of a single response to the trainee's query (keyboard driven text entry).

From a particular training scenario, such as the adolescent patient's first visit to the gynecologist's office to discuss birth control, a collection of video clips is created based upon a story of the interactions between the patient and doctor that is developed by an instructional designer and SMEs. Each video clip will correspond to one potential exchange between the treatment provider and the patient, such as the trainee asking “How are you?” may receive a virtual patient response of “My parent's made me come in to talk to you.” The trainee's experience during the interaction with the virtual patient is based on the behaviors assigned to the virtual patient via the Editor application by the instructional designer and SMEs. The patient's behaviors reflect the specific situations and personalities deemed instructionally important by the SMEs and instructional designer.

Given the dynamic nature of the proposed platform, the script will contain conversational tangents. These tangents are needed for situations when the trainee asks a question outside of the realm that the instructional designer and the SMEs had anticipated. For example, a tangential patient response may occur when the virtual patient does not understand the relevance of a question and may respond with an awkward moment of silence, such as if our adolescent patient is asked “How is the stock market?” These tangents will then be combined with the main thread of the conversation to provide the platform with the ability to respond in situations when the trainee asks questions that are outside the expected scope (and AI logic) of the specific training scenario. Specifically, a series of default responses (ie, blank stare, fidgeting, confused look) will be included in the script for cases when the AI does not know how to respond to the trainee's question.

Considering the example of the adolescent female virtual patient, by giving the adolescent patient a high initial trust value, the virtual patient will be more willing to discuss her situation with the trainee. Alternatively, by setting a low initial trust value, the patient will be hesitant to open up and discuss her situation with the trainee, thus requiring the trainee to ask more methodical, comforting types of questions during the beginning of the scenario. By adjusting the mood parameters correlating to each patient response (video clip), the scenario difficulty can be adjusted, as well as the experience that the trainee gets from replaying the scenario.

Considering the example of a dynamic conversation between a physician and our adolescent patient using the proposed methodology of PSO. For the following discussion, maximum values for the described variables is 100; minimum value is 0 (ie, 0<=value<=100).

From the scenario database, patient initial values are set for: accumulated_trust: (10); she has some inherent trust in the physician authority figure accumulated_topic_comfort: (0); she's uncomfortable about the topics of birth control and her relationship with parents; accumulated_sense_of_urgency: (0); she has no urgency to discuss birth control with the physician

A dynamic, non-linear approach to questioning the patient is required in order to successfully move the conversation forward. If the trainee immediately begins questioning the patient about her sexual activity, the patient responds with angry answers. Although she has some level of trust in the physician, she's unwilling to immediately discuss this topic; the physician must proceed with care to establish a relationship with the patient by taking notice of her reactions. [00XX] Perhaps she's presenting a clue topic to further discuss, such as her desire to get back to her boyfriend after this appointment. Only by asking questions based on clues within her feedback will she be willing to continue the dialog. An example of the simulation is illustrated below:

If the trainee asks a question about her boyfriend and how long they've been dating, the AI parses the question searching for keywords, then maps the candidate responses into 3D space and determines the closest spatial response and updates the patient's mood parameter (green dot in FIG. 4). trust+10; (total is accumulated_trust=20) topic_comfort+10; (total is accumulated_topic_comfort=10) sense_of urgency+5; (total is accumulated_sense_of urgency=5)

or

If the trainee repeatedly continues asking questions that the patient is not willing to discuss, threshold values set within the scenario database will reduce the patient's mood towards the trainee. trust−5; (total is accumulated_trust=5) topic_comfort−1; (total is accumulated_topic_comfort=0; 0 is minimum value) sense_of_urgency 0; (no change; accumulated_sense_of urgency=0)

The trainee must comfort and build trust with the patient. Internally, the virtual patient's mood is updated spatially within 3D space, and the virtual patient's AI is willing to entertain additional scopes of questioning based upon relevance to the current mood (i.e., questions must be both keyword and spatially relevant; Alternatively, if the trainee paid no regard to the patient's negative feedback to the initial questioning and attempted to proceed with a sterile, linear approach to questioning, the patient would become more agitated and might even leave the doctor's office in mid-interview. As the virtual patient's AI mood increases, the patient is more willing to discuss a wider range of topics contained within the training scenario. The trainee has the opportunity to learn and get positive results by adapting his questions to the emotional feedback provided by the virtual patient.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

1. A teaching module comprising:
a training scenario database, said training scenario database having a plurality of video clips, audio files and associated artificial intelligence metadata to simulate a person's personality and mood;
a computer editor component to facilitate the creation of a training scenario involving said simulated person;
a computer student component to facilitate interaction with said training scenario by a user; and
a computer AI component to algorithmically calculate and update the simulated person's personality and mood based on the interaction by said user to provide realistic responses allowing said user to learn how to respond to the simulated person to achieve a desired result

2. The teaching module of claim 1 wherein said training scenario database further comprises a library of specific training scenarios that can be accessed by a plurality of users.

3. The teaching module of claim 1 wherein said interaction by said user is in the form of dialog imputed by said user.

4. The teaching module of claim 3 wherein said training scenario database further comprises a plurality of default responses which are used when said computer AI component is unable to respond to input by said user.

5. The teaching module of claim 1 wherein said simulated person is a simulated patient and said user is a medical student.

6. The teaching module of claim 5 wherein said computer AI component to alter the simulated person's personality and mood to simulate believable patient behaviors.

7. The teaching module of claim 1 wherein said computer editor component comprises a graphical user interface and a database connector.

8. The teaching module of claim 1 wherein said computer student component comprises a graphical user interface, an artificial intelligence logic component and a database connector.

9. The teaching module of claim 1 wherein said computer AI component comprises a dynamically linked library, said dynamically linked library having capability to accept textual input from said computer student component and compare said textual input against keywords contained within said training scenario database, said dynamically linked library having the capability to simulate realistic human behavior for said simulated person.

10. The teaching module of claim 1 wherein said training scenario database, said computer editor component, said computer student component and said computer AI component are located in a single computer.

11. The teaching module of claim 1 wherein said training scenario database, said computer editor component, said computer student component and said computer AI component are located over a network of computers.
